(19) United States
(12) Patent Application Publication
(10) Pub. No.: US 2014/0157133 A1
(43) Pub. Date: Jun. 5, 2014

(54) System And Methods for Generating Surveys

(71) Applicant: Chian Chiu Li, Fremont, CA (US)

(72) Inventor: Chian Chiu Li, Fremont, CA (US)

(21) Appl. No.: 13/691,808

(22) Filed: Dec. 2, 2012

(51) Int. Cl. G06F 3/0484

(52) U.S. Cl. CPC G06F 3/0484
USPC 715/738

(57) ABSTRACT

Embodiments introduced describe single-action surveys, wherein a survey requires a single action only, such as a single click on a mouse, a single touch, tap, or stroke on a touch screen. Each single action represents selection of one survey answer and the survey window closes automatically after a single action is performed. The survey may be arranged to start after a target event is concluded. In addition, a survey may end by itself within a substantially short period of time in the absence of any selection action.

### FEDERALLY SPONSORED RESEARCH

Not applicable

### SEQUENCE LISTING OR PROGRAM

Not applicable

### BACKGROUND

1. Field of Invention

This invention relates to generating surveys, more particularly to generating quick and less intrusive surveys.

2. Description of Prior Art

Customer surveys are important for all kinds of business. Surveys on social or political issues are also important for policy makers as well as the general public. For business, survey results may be used to monitor customer service, improve product quality, detect defects, observe future trends, etc. Traditional surveys use a questionnaire that includes multiple questions. The questions are often long and take time to comprehend, and a questionnaire often contains several pages. No matter whether a questionnaire is on paper or on a screen, most people usually just shy away from it because, it is considered burdensome and intrusive. In many cases, even the allure of raffle prize won't make many people answer survey questions.

Therefore, there exists a need for a survey which is quick, easy, and less intrusive.

### OBJECTS AND ADVANTAGES

Accordingly, several main objects and advantages of the present invention are:
a). to provide an improved system and method to generate or conduct a survey;
b). to provide such a survey which is quick, convenient, and less intrusive;
c). to provide such a survey which requires only a single action;
d). to provide such a survey where a single action includes simple and easy moves, such as a click, touch, stroke, motion, or sound; and
e). to provide such a survey which ends automatically and quickly when no action is taken.

Further objects and advantages will become apparent from a consideration of the drawings and ensuing description.

### SUMMARY

In accordance with the present invention, a survey is designed which may need a single action only. A survey session may begin right after a target event is completed. The survey may involve just one action, such as a touch, a click, a slide, a motion, or a sound. Each single action may provide a specific survey answer and conclude the survey in the meantime. If no action is taken, the session may stop automatically after a sufficiently short period of time, making it less intrusive. The survey process is brief, simple, convenient, and less troublesome compared to completing a traditional questionnaire. As a result, participation of such a survey may be more likely than before.

### DRAWING FIGURES

FIG. 1 is a block diagram describing one embodiment in accordance with the present invention.

FIG. 2 is a flow diagram showing single-action survey of one embodiment in accordance with the present invention.

FIGS. 3 and 4 are illustrations of one embodiment in accordance with the present invention.

FIGS. 5 and 6 are flow diagrams depicting surveys having single-action features in accordance with the present invention.

FIGS. 7 and 8 are illustrations of two embodiments in accordance with the present invention.

FIG. 9 is a flow diagram showing single-action survey of one embodiment in accordance with the present invention.

FIGS. 10-12 are illustrations of three embodiments in accordance with the present invention.

REFERENCE NUMERALS IN DRAWINGS

| 10 | Client System | 12 | Survey Database |
|---|---|---|---|
| 14 | Communication Network | 16 | Processor |
| 18 | Processing Module | 20 | Log Database |
| 22 | Computer Readable Medium | | |
| 24 | Message | 26 | Survey Subject |
| 28 | Graphic Object | 30 | Graphic Object |
| 31 | Message | 32 | Graphic Object |
| 33 | Close Button | 34 | Survey Icon |
| 35 | Close Button | 36 | Display Surface |
| 38 | Window | 40 | Comment Pad |
| 42 | Button | 44 | Button |
| 46 | Button | 48 | Display |
| 50 | Client System | 52 | Keypad |
| 54 | Display Surface | 56 | Graphic Object |
| 58 | Graphic Object | 60 | Graphic Object |
| 62 | Survey Icon | 64 | Survey Window |
| 66 | Client System | 68 | Client System |
| 70 | Survey Window | 72 | Display Surface |
| 74 | Speaker | 76 | Microphone |
| 78 | Client System | 80 | Client System |
| 82 | Server System | 84 | Hand |
| 86 | Check Mark | | |

100, 102, 104, 106, 107, 108, 110, 112, 114, 116, 117, 118, 120, 122,
124, 128, 130, 132, 134, 136, 138, 140, 142, 144 are exemplary steps.

### DETAILED DESCRIPTION

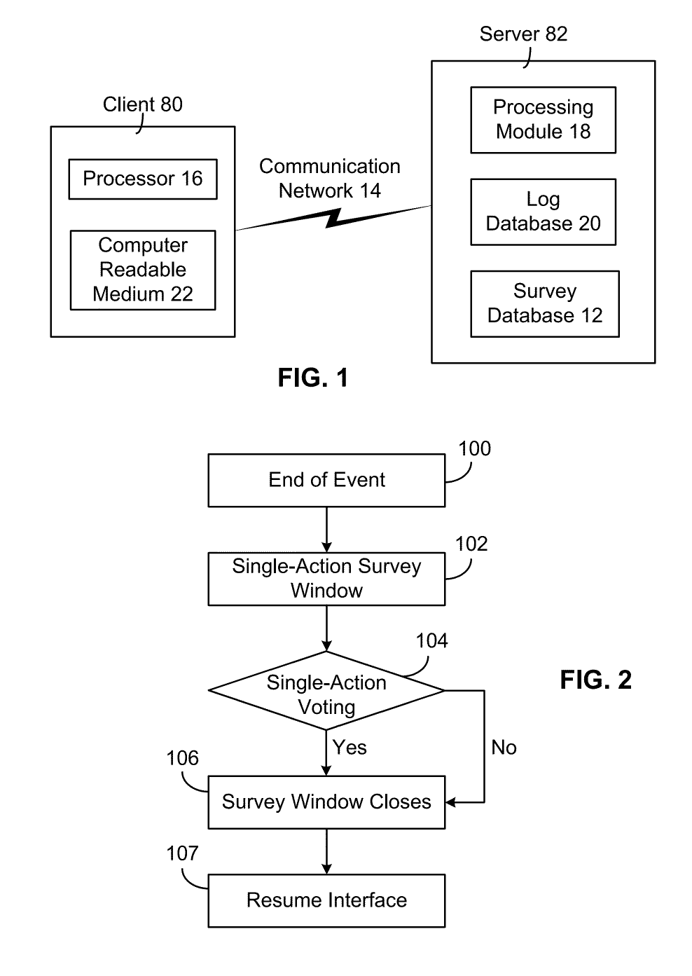

FIG. 1 is an exemplary block diagram of one embodiment according to the present invention. A client system 80 and server system 82 are connected via a communication network 14. Client 80 may represent an electronic device, including but not limited to a desktop computer, a handheld computer, a tablet computer, a wireless gadget (such as mobile phone, smartphone, media player, personal digital assistant (PDA), and the like), digital television (DTV), internet protocol television (IPTV), play station, etc. Client 80 may include a processor 16 and computer readable medium 22. Processor 16 may mean one or more processor chips or systems. Medium 22 may include a memory hierarchy built by one or more memory chips or storage modules like RAM, ROM, FLASH, magnetic, optical and/or thermal storage devices. Processor 16 may run programs or sets of executable instructions stored in medium 22 for performing various functions and tasks, e.g., playing music, electronic payment, single-action survey, etc. Client 80 may also include input, output, and communication components, which may be individual modules or integrated with processor 16. Usually, client 80 has a display with a graphical user interface (GUI). The display surface may also be sensitive to touches, especially in the case of tablet computer or smart phone. Client 80 may also have a voice recognition component to receive audio input from a user.

The word “server” means a system or systems which may have similar functions and capacities as one or more servers. Main components of server may include one or more processors, which control and process data and information by executing software, logic, code, or carrying out any other suitable functions. A server, as a computing device, may include any hardware, firmware, software, or a combination. In the most compact form, a server may be built on a single processor chip. In the figure, server 82 may represent one or more server entities that collect, process, maintain, and/or manage survey information and documents, conduct surveys, communicate with users, deliver information required by users, etc. Server 82 may exemplarily be divided into three blocks, represented by a processing module 18, a log database 20, and a survey database 12. Processing module 18 may include processing and communication functions. Log database 20 may store user ID information and survey ID information, which may be used to trace a survey result a user produced. Survey database 12 may store survey results and other survey related information, such as information on the survey event. The databases may include aforementioned memory chips and/or storage modules.

A communication network 14 may cover a range of entities such as the Internet or the World Wide Web, a local area network (LAN), a wide area network (WAN), a metropolitan area network (MAN), a telephone network, an intranet, wireless, and other types of networks. Client 80 and server 82 may be connected to network 14 by various wired, wireless, optical, or other connections.

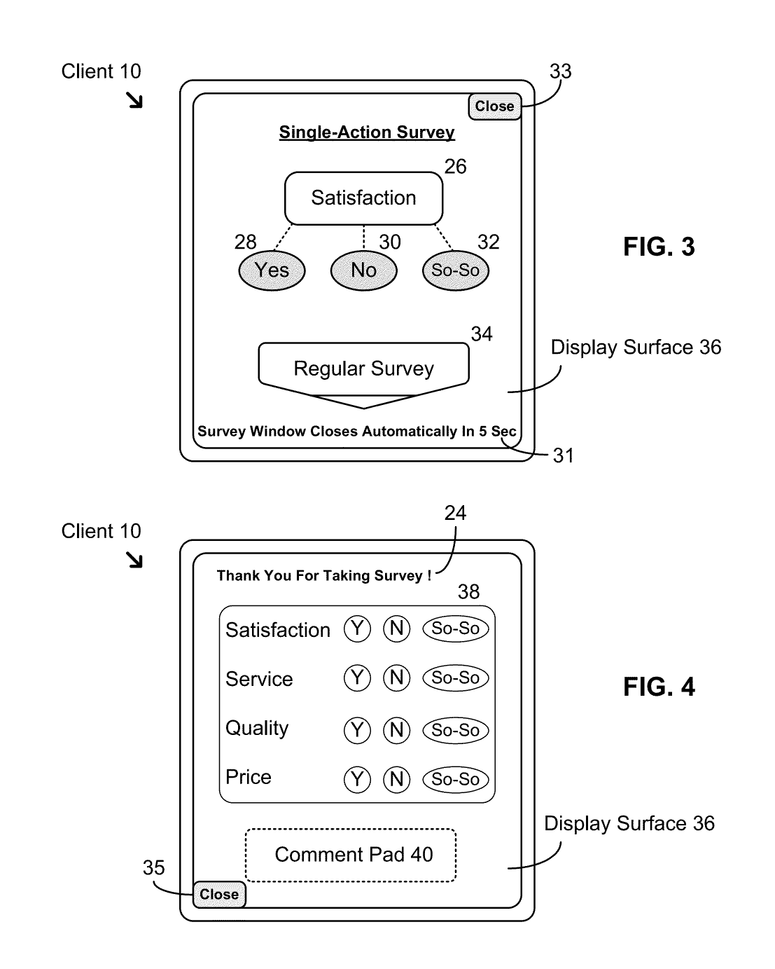

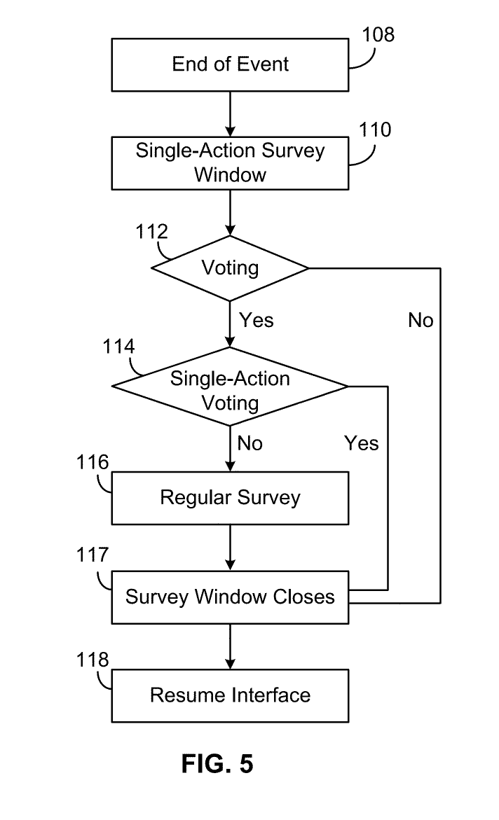

FIG. 2 is a schematic flow diagram illustrating one embodiment of a single-action survey according to the present invention. FIG. 3 is an exemplary diagram of a client system 10 that may be used to illustrate the flow diagram of FIG. 2. Client 10 has a display surface 36, where messages and graphic objects may be presented. Graphic objects may represent documents, applications, and functions, e.g., a textual file, photo album, browser, email, music, etc. Display surface 36 is also a GUI by which a user may interact with the client system and/or a remote server. Surface 36 may be a touch screen or touchscreen, which is sensitive to a touch or touches. A graphic object on the GUI of a touch screen may be selected or activated by a click on a mouse or more conveniently, by a touch of finger tip.

Returning to FIG. 2. Step 100 represents the end of a target event. The event may be business related transactions on line or in retail stores, or a process which is not business related. Examples of event include online shopping, in-store shopping, dining, service, gaming, show, sport, and so on. Next in Step 102, a survey window shows up, which may be depicted by FIG. 3. The view on surface 36 of FIG. 3 may be considered as a survey window, where a title says “Single-Action Survey” and a graphic object 26 indicates the survey subject is “Satisfaction”. Below object 26, there are objects 28, 30, and 32, corresponding to “Yes” (satisfied), “No” (not satisfied), and “So-So” (average) respectively. The three objects represent three answers for a single-action survey and are used to illustrate survey process for various embodiments. In practice, more than three answers may be arranged for providing surveys with more details. For example, five answers may be prepared which may be very good, good, average, bad, and very bad. However, the answer selection format would be more acceptable if it is simple, concise, and straightforward, which is also part of the essence of single-action survey. In Step 104 “Single-Action Voting”, a user may choose to participate or not to participate in the survey. When participating in the survey, a user may choose from the three answers, i.e., selecting one or voting one among objects 28, 30, or 32. Selecting an object may be implemented by a click on it using a mouse or a touch on it on surface 36 if the surface is touch sensitive. The single-action survey is configured such that selecting any of objects 28, 30, and 32 results in Step 106, closure of the survey window and ending of the survey. If a user doesn't want to take the survey, he or she may select a “Close” button 33 on the GUI or surface 36. Alternatively, if a user doesn't select any object within a sufficiently short period of time, it may be deemed “not participating” and the survey window and survey session will be closed automatically. Finally, Step 107 may resume the interface on surface 36 before the survey or return to a predetermined GUI.

The above described survey requires only one action, a click, a touch, or other single actions as discussed below, or no action. The whole survey process is simple, swift, easy, and less intrusive, and thus more likely to be accepted by users than a traditional survey. For example, when a user purchases a cup of coffee at a coffee shop, a smartphone may be used to pay for it in an electronic payment process. The transaction may be concluded after the user waves the smartphone in front of a cash register. Then a survey window may appear on the smartphone's touch screen or GUI. The user may give a quick touch on the screen, maybe costing one or two seconds. After that, the survey ends, the survey window closes automatically, and the smartphone screen may return to its previous GUI.

Therefore compared to a traditional questionnaire style survey, a single-action survey is more convenient, takes less time, and thus may be more acceptable. Although single-action surveys have a simple format, for a shop manager, the survey may yield important information about product quality and customer service.

Back to FIG. 1, a single-action survey may be executed by processor 16. The launch of survey may be triggered by a monitoring program of the client system that receives the information of event completion, or by instructions sent by an organization which conducts or oversees the event, or a third party which is informed of the event status. The third party may be a local device or a remote system. It is noted that a client system may or may not in involved in a target event. For example, a smartphone may be used for electronic payment and then for a survey after the payment. On the other hand, when a credit card is used for payment, and a smartphone is registered with the credit card, the smartphone may receive instructions to start a survey too. Survey related information, including case ID, user ID, survey result, and event info may be sent to server 82 by processor 16 via network 14. Server 82 may store case ID, survey results, and event info in survey database 12, and keep user ID and case ID in log database 20. Alternatively, survey related information may be transmitted to a local device which then relays the information to a remote server. In addition, processor 16 may send the survey related information to a local device which passes it to a local database. For example, the aforementioned coffee shop may want to keep to itself the survey data collected from its customers.

The single-action survey window of FIG. 3 may also contain other functions in the GUI. For example, there may be a message 31 assuring users the survey window will close by itself in five seconds. In order to reduce intrusiveness, the window should be closed automatically when a user is busy with other things or ignores the survey. And the window should be closed quickly, say within a period from a couple of seconds to a minute. The GUI or surface 36 may also include a “Regular Survey” object 34 to provide an opportunity for a user to take a regular or traditional survey that has multiple questions. Once object 34 is selected, another survey window shows up in the GUI, signaling a new survey session.

FIG. 4 shows an exemplary embodiment of a regular survey in accordance with the present invention. The GUI in FIG. 4 may be generated after a user chooses an option to take a regular survey. Below a “Thank You” message 24, there are listed exemplary questions, such as opinions on satisfaction, service, quality, price, etc. More questions and/or more pages may be provided for a regular survey. At the bottom of the GUI, a comment pad 40 may also be provided for users to express more on their experience and feelings with their own words.

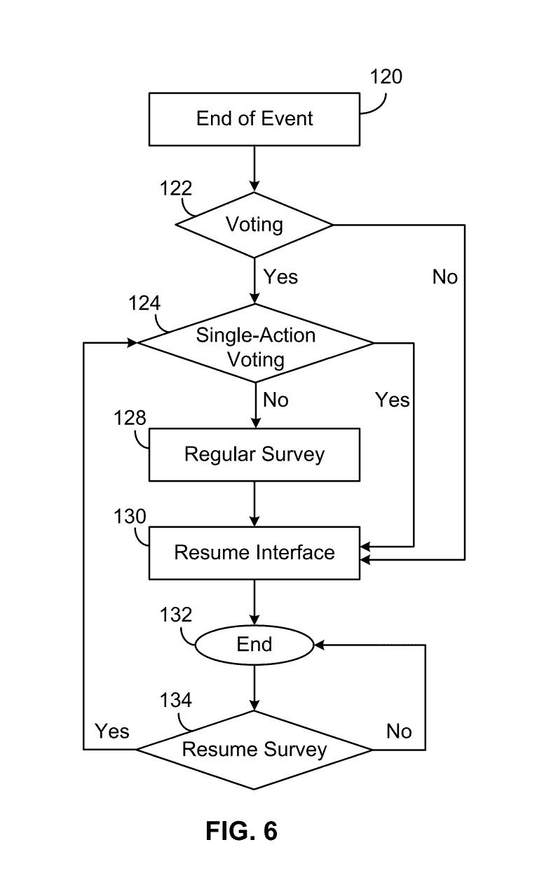

FIG. 5 is a schematic flow diagram of one embodiment having a regular survey option. It starts with Step 108, the end of an event. Next a single-action survey window shows up in Step 110. A user then can choose whether or not to participate in the survey in Step 112. If the answer is no, the user may use a single click or single touch to close the survey window (e.g., selecting a “Close” button), or ignore the survey by doing nothing, which prompts step 117, closure of the survey window. If the user wants to take the survey, he or she may take advantage of the single-action process to answer one question, which also leads to Step 117, closing the survey window. On the other hand, the user may skip the single-action voting and enter Step 116, and then take a regular survey with multiple questions and a platform for commenting, which is followed by window closing step 117. Finally in Step 118, the GUI may resume its original state.

FIG. 6 shows a schematic flow diagram of another embodiment in accordance with the present invention. Like the flow diagram of FIG. 5, the process begins with the end of an event in Step 120. Next, a survey window opens (not shown in the figure for simplicity reasons). If a user doesn't want to take part in the survey in Step 122, the window closes with a single action or no action, and the GUI returns to its previous setting in Step 130. If a user participates in the survey, a single-action voting may take place in Step 124, and the original GUI resumes in Step 130 after closure of the survey window. Additionally, a user may choose to pass the single-action voting, and go to a regular survey in Step 128. After that, the GUI resumes in Step 130. Returning to the previous GUI may mean Step 132, the end of the survey. But in real life, users may want to adjust their submitted answers, or rewrite a comment afterwards. Thus a client system may provide an option or application which allows a user to redo a survey or return to a previous survey session. In Step 134, a user may decide whether to go back to the survey. Going back means returning to Step 124 with the GUI displaying a single-action survey window, where there are options for single-action and regular surveys. Referring to FIG. 1, in order to resume a survey, client 80 may send to server 82 a request, plus the customer's user ID and case ID. Server 82 may verify the ID information based on the data stored at log database 20, locate a survey result at database 12 according to the ID info, and then send it to client 80. Once the user redoes the survey, the result is sent to server 82. Then database 12 is updated using the new result. It may be designed such that a user may change a survey result multiple times within a time frame.

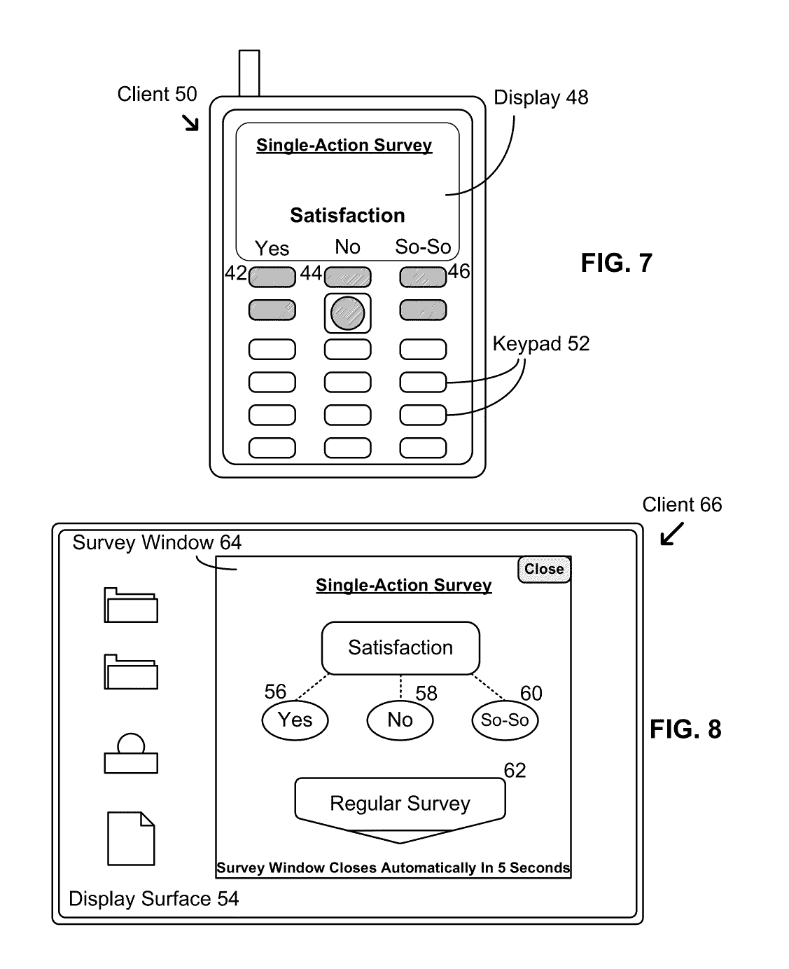

FIG. 7 shows exemplarily a diagram of one embodiment. A client system 50 may be a mobile phone which has a keypad 52, but has no touch screen. A display 48 shows a title “Single-Action Survey” and a survey subject “Satisfaction” at the end of an event. In this design, the three answers “Yes”, “No”, and “So-So” cannot be selected either by touching or clicking. Instead, the survey answer may be chosen by pushing a button 42, 44, or 46. Again, after single-action selection, display 48 returns to a previous setting. Therefore, it is still a single-action survey. The survey program may be embedded in a processor system of client 50; alternatively, it may also be installed as a specific application which may be downloaded from the Internet. Once a survey is concluded, the survey related information may be transmitted by the client processor to a local device, which then forwards it to a local or remote survey database, or to the remote database directly via a communication network.

FIG. 8 is a graphic illustration of yet another embodiment in accordance with the present invention. A client system 66 may be a smartphone, tablet computer or desktop computer. A survey window 64 shows up after an event. The window only takes part of a display surface 54 with file and program icons in the background. Surface 54 may be touch sensitive. Graphic objects 56, 58, or 58, as the three answers of a single-action survey, may be selected by a mouse click, finger touch, or another single action. Alternatively, a user may choose a regular survey by clicking or touching object 62. The survey process and client device functions may be similar to that introduced in the flow diagram of FIG. 6.

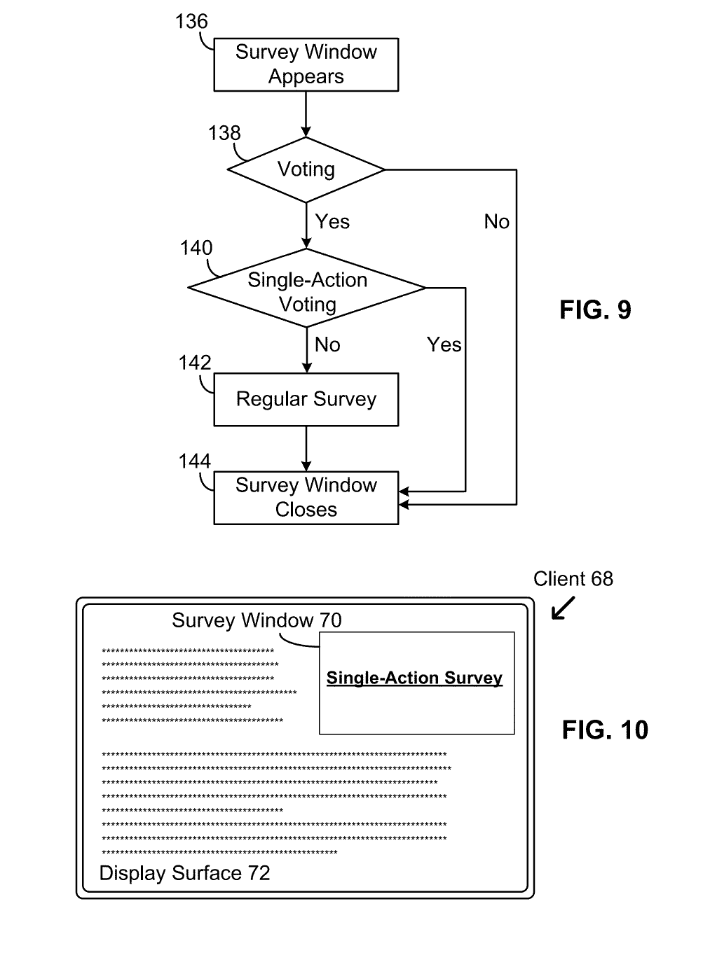

A survey implemented immediately after an event makes it natural and relevant. But some surveys are desirable before an event happens. Examples of this type include survey on social or political issues before election, a product survey before release, a survey on future trends, and so on. Thus for certain subjects, especially popular ones (which means the majority of people qualify for taking a survey), a survey invitation may be sent to users before an event. The users may be randomly chosen, since there is no exact information about who is more relevant to the event. Starting time of the survey may also be randomly arranged. Thus the first survey step may be to create a survey window or just to start it in case there is no display in a client system. FIG. 9 illustrates schematically a flow diagram of one embodiment for such a purpose. Steps 136, 138, 140, 142, and 144 exemplarily depict a survey process involving single-action selection and regular survey, which may be similar to that of FIG. 5 except the start part. Thus the client processor system and other components here may have similar configurations and functions as the aforementioned for other embodiments.

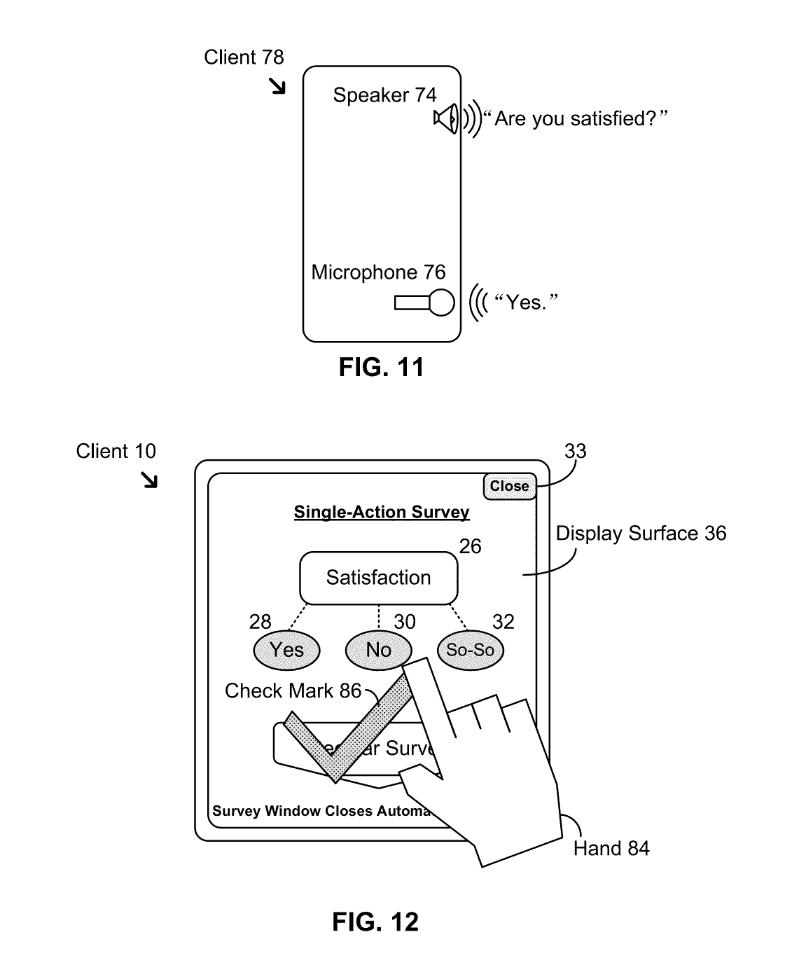

FIG. 10 shows an illustration of one embodiment of a single-action survey for above scenario of FIG. 9. A browser component of a client system 68 may display online contents on the GUI or a display surface 72. As pre-planed, a single-action survey window 70 appears. The popped up window may be arranged so that its appearance doesn't affect the view of the online contents if possible. The survey window may temporarily take an empty space or ad space on surface 72. After a single-action selection is taken, the survey window closes, and the previous GUI resumes. Or if there is no selection detected in a sufficiently brief period of time, survey window 70 closes by itself. Client 68 may be a smart phone, a tablet computer, a desk-top computer, or other electronic gadgets or computing devices. Again, the embodiments of FIGS. 9 and 10 may be useful for collecting opinions on a popular event or phenomenon, governmental policy, or issues involving the general public or a community.

FIG. 11 illustrates an exemplary diagram of yet another embodiment in accordance with the present invention. A client system 78 may include a speaker component 74 and a microphone component 76. Speaker 74 may start a survey by producing an audible question, like “Are you satisfied?” after an event is finished. A user may say to microphone 76, for example, “Yes”, “No”, or “So-so” as an answer. Depending on the system configuration, other words may also be used as a survey answer, such as “Excellent”, “Good”, “Very good”, “Not bad”, “Bad”, and so on. The one-word or short-sentence speech may be considered as a single-action reply, which causes ending of the survey. As other embodiments, the survey may also end if no audible reply is detected. At the end of a survey, client 78 may resume its previous operation status or return to a predetermined setting. Moreover, client 78 may be configured such that if a user answers “Regular survey”, a survey with multiple questions may begin. Thus it is yet another embodiment of single-action survey which has an option of regular survey. However, unlike aforementioned cases, client 78 may not need a display, because a survey may be carried out audibly through sound and voice. Client 78 may be an electronic device which has a processor system, machine readable memory medium, stored executable instructions (e.g., programs and applications) like client 80 of FIG. 1. Because a display is not involved, Client 78 may eliminate a bulky display component as well as graphic processing related software and hardware. Client 78 may even eliminate mobile phone components, if wireless vocal communication is not in need. The client system may have functions which include starting a survey at the end of a target event or after receiving an instruction, concluding a survey after a single-action takes place or no action happens, and resuming client's operation setting before the survey. Like client 80, the client system may have capability for wired and/or wireless data communication with a local or remote device and electronic payment transaction, besides its unique speech recognition and voice generation capacity, which may be supported by embedded programs and/or installed applications. Since there is no display, client 78 may be made substantially small in size and economic in cost for various mobile and/or disposable uses. For example, the processor system and other components of client 78 may be integrated into a few chips or even one chip, suitable for cost reduction through volume production using semiconductor fabrication technologies.

FIG. 12 is an illustration of one embodiment which provides flexibility and additional convenience for single-action response in a survey. Back to FIG. 3, a single-action voting may be performed by touching object 28, 30 or 32 using a finger. In the process, a user has to make sure his or her finger tip aims at the right object, which may be burdensome when the user is on the run. As surface 36 is sensitive to touches, a contact detection module may be incorporated with client 10 that may detect not only a single touch or multiple touches, but also finger movement or release of the finger contact on surface 36. As well known in the art, the contact detection technologies may include capacitive, resistive, infrared, optical, surface acoustic wave, proximity sensing methods, etc. A proximity sensor array may also be employed to detect gestures of a finger or fingers above the screen surface. Returning to FIG. 12, the embodiment is still illustrated by client 10. Assume client 10 is now equipped with contact sensing technologies and is able to detect a finger touch, finger gesture, or finger motion on surface 36. For example, when a check mark 86 is created by a hand 84 on the screen, client 10 may sense that a check-mark shaped object is drawn. Thus a user may set up a program or install an application which may recognize certain finger movements or gestures and take them as yes, no, or so-so respectively. For example, a scribble making a check mark on surface 36 may be designated as yes, a cross as no, and a straight stroke as so-so. Thus a user may answer a survey question by a quick scribble on the screen, which can be done easily and fast without paying much attention to where his or her finger lands. Therefore the single-action survey may become more convenient and more likely to be accepted.

### CONCLUSION, RAMIFICATIONS, AND SCOPE

Thus it can be seen that systems and methods are introduced to generate improved surveys.

The improved survey has the following features and advantages:
(1). Only a single action is needed;
(2). A single action may include one touch, tap, stroke, click, motion, sound, and other simple one-step moves;
(3). A single-action survey is quick, simple, convenient, less intrusive, and thus may be more acceptable by users.

Although the description above contains many specificities, these should not be construed as limiting the scope of the invention but as merely providing illustrations of some of the presently preferred embodiments. Numerous modifications will be obvious to those skilled in the art.

### Ramifications:

The speech recognition and voice generation functions introduced in FIG. 11 may be incorporated with other embodiments to take advantage of the audio style single action. For example, a survey may start with a voice (like “Are you satisfied?”) and end with a scribbled check mark on the screen, or start with a survey window on a screen and end with a vocal reply. Or a user may switch between audio mode and screen mode depending on different occasions.

Referring to the embodiment of FIG. 12, more finger movements may be utilized to signal single-action answers. For example, tapping using one finger, two fingers, or three fingers may represent the three answers yes, no, or so-so; or touching or tapping on upper, middle and lower section of the screen may reflect the three answers respectively. Besides maneuvers by fingers, as known in the art, movement of hand on a touch screen may also be sensed and thus may be utilized as a single-action response. For example, a single action may be a touch, tap, or slide by hand.

Furthermore, a motion sensing component such as accelerometer and/or gyroscope may be added to a client system which senses motion of the client device. Thus for example, shaking or waving a mobile phone in vertical direction, horizontal direction, or in circle may respectively represent the three answers of a single-action survey.

Lastly, for mobile phone users, the launch of a survey may feature flashes of light from an embedded light emitting module, so that a user may not need to look at the screen closely to know a survey gets started after a target event is over. This feature, when combined with other easy steps, makes a survey even more convenient.

Therefore the scope of the invention should be determined by the appended claims and their legal equivalents, rather than by the examples given.

1. A system having a display and stored executable instructions, comprising:
1) connection component for connecting said system to an electronic device or a communication network;
2) survey means for generating a survey window on said display for conducting a survey;
3) said window configured for receiving a single action for said survey;
4) said system arranged such that said single action causes selection of one of a plurality of predetermined options, said options comprising a plurality of predetermined messages, said system configured such that selecting one of said messages causes closing of said window; and
5) transmission component for transmitting the survey related information to a survey database via said device or said network.

2. The system according to claim 1 wherein said survey window closes automatically in a substantially short period of time in the absence of said single action.

3. The system according to claim 1 wherein at least one of said predetermined messages is related to an event.

4. The system according to claim 1, further including an executable application or program for resuming said survey within a defined period of time after said survey is closed.

5. The system according to claim 1 wherein one of said options includes another survey comprising a plurality of questions.

6. An electronic apparatus having stored executable instructions, comprising:
1) connection component for connecting said apparatus to an electronic device or a communication network;
2) survey component for starting a survey session from a first session;
3) receiving component for receiving a single action performed by a user;
4) said apparatus arranged such that said single action causes selection of one of a plurality of predetermined options, said options comprising a plurality of predetermined messages;
5) closing means for ending said survey session after said selection process is performed;
6) resuming means for resuming said first session or staring a second session; and
7) transmission component for transmitting the survey related information to a survey database via said device or said network.

7. The apparatus according to claim 6 wherein said survey session ends automatically in a substantially short period of time in the absence of said single action.

8. The apparatus according to claim 6 wherein at least one of said predetermined messages is related to an event.

9. The apparatus according to claim 6, further including an executable application or program for resuming said survey session by said user.

10. The apparatus according to claim 6 wherein one of said options includes another survey comprising a plurality of questions.

11. A method performed for generating a survey comprising:
1) providing an electronic device having a display and stored executable instructions;
2) generating a survey window for said survey on said display;
3) said survey window configured for receiving a single action for said survey;
4) said method arranged such that said single action causes selection of one of a plurality of predetermined options, said options comprising a plurality of predetermined messages, said method configured such that selecting one of said messages causes closing of said survey window; and
5) transmitting the survey related information to a survey database via a first device or a communication network.

12. The method according to claim 11, further including closing said survey window automatically in a substantially short period of time in the absence of said single action.

13. The method m according to claim 11 wherein at least one of said predetermined messages is related to an event.

14. The method according to claim 11, further including resuming said survey within a defined period of time after said survey is closed.

15. The method according to claim 11 wherein one of said options includes another survey comprising a plurality of questions.

16. A method performed for conducting a survey comprising:
1) providing an electronic device having stored executable instructions and a first session;
2) generating a survey session;
3) said survey session configured for receiving a single action for said survey;
4) said method arranged such that said single action causes selection of one of a plurality of predetermined options, said options comprising a plurality of predetermined messages, said method configured such that selecting one of said messages causes ending of said survey session;
5) resuming said first session or starting a second session; and
6) transmitting the survey related information to a survey database via a first device or a communication network.

17. The method according to claim 16, further including closing said survey session automatically in a substantially short period of time in the absence of said single action.

18. The method m according to claim 16 wherein at least one of said predetermined messages is related to an event.

19. The method according to claim 16, further including resuming said survey session within a predetermined period of time upon a request by a user.

20. The method according to claim 16 wherein one of said options includes another survey comprising a plurality of questions.
